(19) United States
(12) Patent Application Publication
(10) Pub. No.: US 2019/0078769 A1
(43) Pub. Date: Mar. 14, 2019

(54) PORTABLE LIGHT

(71) Applicant: Xiamen PVTECH Co., Ltd., Xiamen (CN)

(72) Inventors: FUXING LU, Xiamen, Fujian (CN); RUICHA LAI, Xiamen, Fujian (CN)

(21) Appl. No.: 15/839,877

(22) Filed: Dec. 13, 2017

(30) Foreign Application Priority Data
Sep. 8, 2017 (CN) 201710806236.8

(51) Int. Cl. F21V 23/04; F21V 21/08; F21S 8/00; F21S 9/02; F21V 19/00; F21V 29/83

(52) U.S. Cl. CPC F21V 23/04; F21V 21/08; F21S 8/033; F21Y 2115/10; F21V 19/0015; F21V 29/83; F21S 9/02

(57) ABSTRACT

A portable light includes an extruded frame. The extruded frame includes two side plates, a top plate connected to the side plates, and a bottom plate connected to the side plates. A width between top portions of the side plates is less than a width between bottom portions of the side plates. The portable light further includes a housing, an LED module, a power device, and a manual switch including a pulling line extending out of the extruded frame. The portable light is used for shop illumination. A user can pull the pulling line to turn on or off the portable light. Notches of the extruded frame improve the heat dissipation. A protruded arced surface of the housing increases an illumination area of the portable light. Accordingly, the light emitted by the LED module is passing through the protruded arced surface to provide a uniform and larger illumination area.

### BACKGROUND OF THE INVENTION

### 1. Field of the Invention

The present invention relates to a light, in particular to a portable light.

### 2. Description of the Prior Art

The conventional LED lights used in shops are adapted to be assembled on the ceiling or on the light-gauge steel frame of the building. The LED lights are easy for assembly and repairing, and the LED lights are energy-saving, high illumination, and in small volumes. Therefore, when LED lights are used to be assembled on the ceiling or on the light-gauge steel frame of the building, the illumination efficiency of the lights can be greatly improved and the energy consumption of the lights can be greatly reduced. The main component of the LED light, i.e., light-emitting diode (LED), is a new generation solid power source. The LEDs have advantages like, long lifetime, high efficiency in energy conservation, environmental-friendly, etc., and the LEDs are widely used in display and lighting.

The conventional LED light bars used in shops are provided for illumination with energy-saving purposes. However, the conventional LED light bars have dissipation problems. As a result, the so-called “LED light bars” are used with LEDs having lower powers. Moreover, conventional lights used in shops are mostly controlled by a switch assembled on the wall of the building to be turned on or turned off. Thus, Operations of the lights are not so convenient. Furthermore, some conventional lights are used with a single light tube (or a single light bulb) , and the illumination area is confined to a limited range. Therefore, when a larger area has to be illuminated, more lights have to be assembled. Accordingly, how to solve the problems is an issue.

### SUMMARY OF THE INVENTION

In this embodiment, the portable light is used for shop illuminations, and the portable light is also called shop light. The structure of the extruded frame and the notches on the surface of the extruded frame allow the portable light to have great heat dissipation. When the LED module emits lights, though the heat generated by the LED module is gathered on the circuit board, such heat can be dissipated through the extruded frame. Therefore, the LED module does not have luminous attenuation due to being overheating.

In this embodiment, the pulling line is extending from the portable light, so that a user can pull the pulling line to turn on or turn off the portable light in a convenient manner. Conversely, it is understood that the conventional light can be turned on or turned off by the switch assembled on the wall, resulting in inconvenience for the user.

The LED module may be a high luminous-power LED module or a low luminous-power LED module, and the luminous power of the LED module may be up to 70 W. Furthermore, because the heat dissipation problem of the LED module is solved, the LED module may comprise LEDs with less number but higher luminous power to improve the illumination efficiency.

Moreover, the protruded arced surface of the housing increases an illumination area of the portable light. Accordingly, when the light emitted by the LED module is passing through the protruded arced surface, a uniform and larger illumination area can be provided. Additionally, the connectors of several portable lights can be connected with each other through wires, so that several portable lights can be connected with each other in series connection for further use.

Moreover, it is understood that the surface of the frame of a conventional light has extrusion marks, and the extrusion marks may be damaged or deformed easily when being forced. In one embodiment, the extruded frame of the portable light has a proper design in which the surface of the extruded frame provided with the notches. The notches form a decoration structure for the extruded frame without extrusion marks. Moreover, the notches allow the extruded frame to have improved structural strength and not to deform easily.

One embodiment of the present invention provides a portable light, wherein the portable light comprises an extruded frame. The extruded frame comprises two side plates, a top plate connected to top portions of the two side plates, and a bottom plate connected to bottom portions of the two side plates. A width between the top portions of the two side plates is less than a width between the bottom portions of the two side plates. The portable light further comprises a housing fixed on one side of the bottom plate, an LED module located in the extruded frame, a power device received in the extruded frame and electrically connected to the LED module, and a manual switch electrically connected to the LED module to control the LED module to be turned on or off. The manual switch comprises a pulling line extending out of the extruded frame.

In some embodiments, the bottom plate is recessed inwardly toward the receiving space, so that an area of the light illumination space increases. Two ends of the extruded frame are combined with side covers, and a surface of each of the side covers forms a connector.

In some embodiments, a surface of the extruded frame forms a plurality of notches.

In some embodiments, a protruding arced surface is formed on the housing to increase an illumination area of the portable light.

In some embodiments, two ends of the housing are provided with engaging grooves, and two ends of a side portion of the extruded frame are provided with engaging blocks for being engaged with the engaging grooves.

In some embodiments, a cross-sectional area of the extruded frame forms a rectangular structure with a width of the rectangular structure being gradually increasing from one of two opposite side of the rectangular structure to the other side of the rectangular structure.

In some embodiments, a plurality of hooks is assembled on the other side of the rectangular structure of the extruded frame.

The manual switch comprises a connection member, and the extruded frame comprises a positioning groove for positioning with the connection member.

In some embodiments, a luminous power of the LED module is 70 W.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of a portable light according to an exemplary embodiment of the present invention;

FIG. 2 illustrates a sectional view of the portable light;

FIG. 3 illustrates a sectional view showing an extruded frame and a housing of the portable light;

FIG. 4 illustrates a side view of the portable light;

FIG. 5 illustrates an exploded view (1) of the portable light;

FIG. 6 illustrates an exploded view (2) of the portable light; and

FIG. 7 illustrates another perspective view of the portable light.

### DETAILED DESCRIPTION

A portable light 100 is provided and used for shop illuminations. The portable light 100 is also called shop light. A LED module 4 of the portable light 100 may be a high luminous-power LED module or a low luminous-power LED module, and the luminous power of the LED module 4 may be up to 70 W. A pulling line 7 is extending out of the portable light 100, so that a user can pull the pulling line 7 to turn on or turn off the portable light 100.

Embodiments are described by the following paragraphs along with appended drawings. However, it is understood that, these embodiments may have modifications and they shall not be used for interpreting the claimed scope of the present invention. These embodiments allow the disclosure of the present invention to be full and clear. Therefore, person having ordinary skills in the art can realize the scope of the invention from these embodiments.

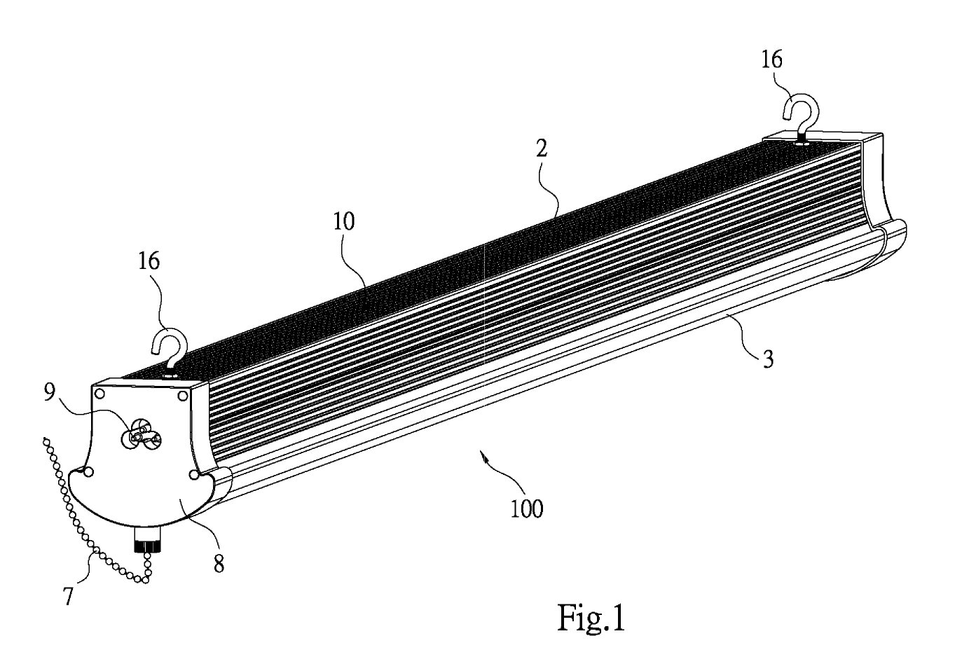

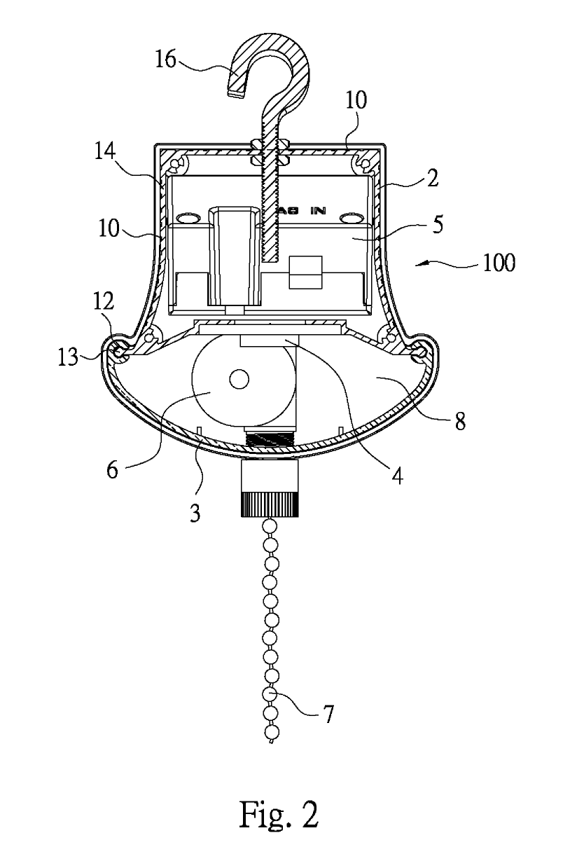

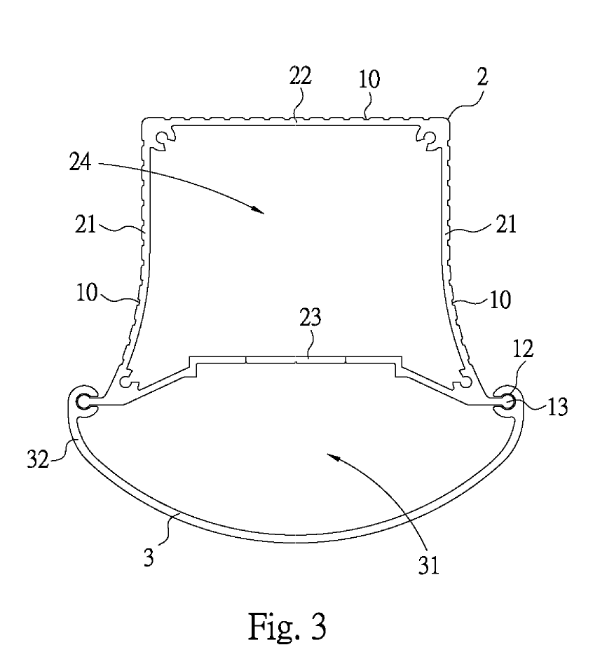

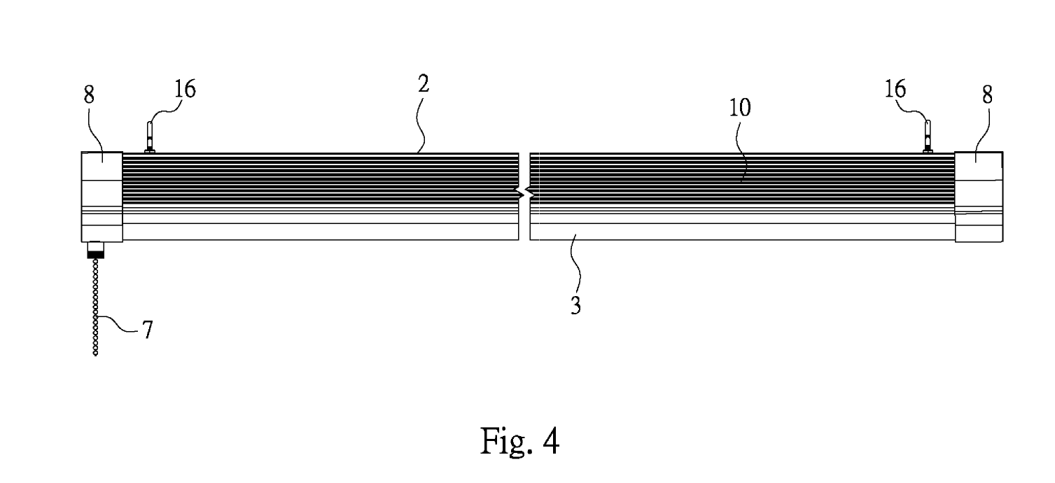

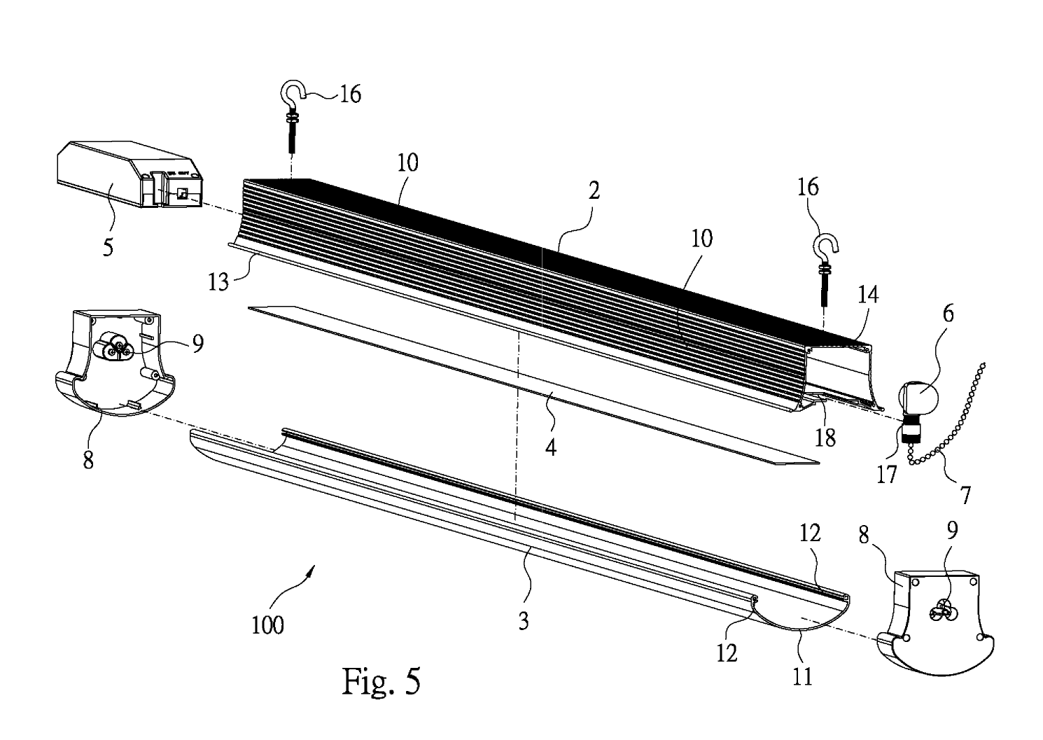

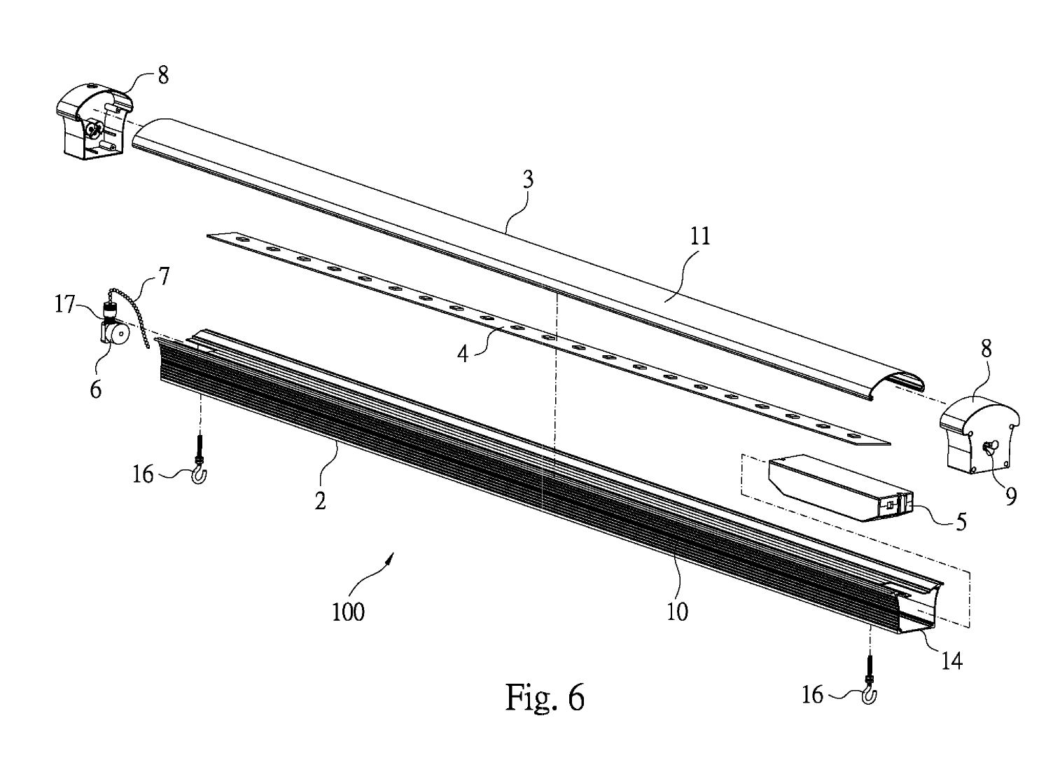

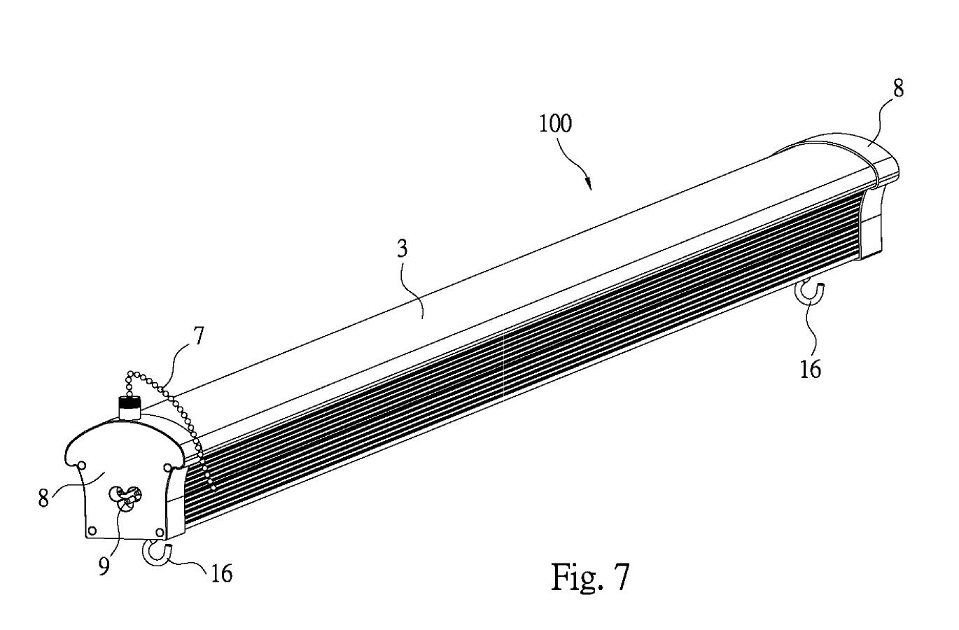

Please refer to FIGS. 1 to 7. FIG. 1 illustrates a perspective view of a portable light according to an exemplary embodiment of the present invention. FIG. 2 illustrates a sectional view of the portable light. FIG. 3 illustrates a sectional view showing an extruded frame and a housing of the portable light. FIG. 4 illustrates a side view of the portable light. FIG. 5 illustrates an exploded view (1) of the portable light. FIG. 6 illustrates an exploded view (2) of the portable light. FIG. 7 illustrates another perspective view of the portable light. In this embodiment, the portable light 100 comprises an extruded frame 2, a housing 3, an LED module 4, a power device 5, and a manual switch 6.

Please refer to FIGS. 1 to 7. The extruded frame 2 is a hollowed frame structure. The extruded frame 2 comprises two side plates 21, a top plate 22, and a bottom plate 23. The top plate 22 is connected to top portions of the two side plates 21. The bottom plate 23 is connected to bottom portions of the two side plats 21. A width between the top portions of the two side plates 21 is less than a width between the bottom portions of the two side plates 21. Namely, a cross-sectional area of the extruded frame 2 forms a rectangular structure in which a width of the rectangular structure gradually increases from the top to the bottom. Therefore, the housing 3 with a greater width can be assembled to the bottom of the extruded frame 2.

Please refer to FIGS. 1 to 7. The extruded frame 2 comprises a receiving space 24 defined by the two side plates 21, the top plate 22, and the bottom plate 23. The power device 5 is placed in the receiving space 24. The receiving space 24 facilitates air convention. Therefore, the receiving space 24 allows heats generated by the power device 5 or the LED module 4 to be transmitted to a cooler portion within the extruded frame 2, so that the portable light 100 has improved heat dissipation.

Please refer to FIGS. 1 to 7. The housing 3 is fixed on the bottom plate 23, and a light illumination space 31 is formed between the bottom plate 23 and the housing 3. The bottom plate 23 is recessed inwardly toward the receiving space 24. Therefore, the distance between the bottom plate 23 and the housing 3 increases. Accordingly, the area of the light illumination space 31 increases, and the area for air convention also increases. Hence, the receiving space 24 allows heats generated by the LED module 4 to be transmitted to a cooler portion within the extruded frame 2, so that the portable light 100 has improved heat dissipation.

Please refer to FIGS. 1 to 7. A cross-sectional area of the extruded frame 2 forms a rectangular structure 14 in which a width of the rectangular structure 14 gradually increases. A protruded arced surface 11 is formed on the housing 3 to increase an illumination area of the portable light. Accordingly, when the light emitted by the LED module 4 is passing through the protruded arced surface 11, a uniform and larger illumination area can be provided.

Please refer to FIGS. 1 to 7. The extruded frame 2 is made by aluminum-extruded profiles. A surface of the extruded frame 2 forms a plurality of notches 10. It is understood that the surface of the frame of a conventional light has extrusion marks, and the extrusion marks may be damaged or deformed easily when being forced. In one embodiment, the extruded frame 2 of the portable light 100 has a proper design in which the surface of the extruded frame 2 is provided with the notches 10. The notches 10 are chamfered to prevent injury. The notches 10 forma decoration structure for the extruded frame 2 without extrusion marks. Moreover, the notches 10 allow the top plate 22 and the side plates 23 to have improved structural strength. Hence, extruded frame 2 does not deform easily.

Please refer to FIGS. 1 to 7. Two ends of the extruded frame 2 are combined with side covers 8. A surface of each of the side covers 8 forms a connector 9. The connector 9 is adapted to be connected to a wire (mains electricity). Alternatively, the connectors 9 of several portable lights 100 can be connected with each other through wires, so that several portable lights 100 can be connected with each other in series connection for further use.

Please refer to FIGS. 1 to 7. The housing 3 is fixed on one side portion of the extruded frame 2. Two ends of the housing 3 are provided with engaging grooves 12. The engaging grooves 12 are approximately C-shaped. Two ends of the side portion of the extruded frame 2 are provided with engaging blocks 13. The engaging blocks 13 are protruding structures. Accordingly, by engaging the engaging blocks 13 with the engaging grooves 12, the housing 3 is fixed on the side portion of the extruded frame 2 and not detach from the extruded frame 2.

Please refer to FIGS. 1 to 7. Two extending arms 32 are extending from the two ends of the housing 3 in a same direction, such that the housing 3 forms an arch-like structure and the housing 3 can have elongated length and expanded area. Accordingly, when the light emitted by the LED module 4 is passing through the protruded arced surface 11, a uniform and larger illumination area of the lighting can be provided via the housing 3 having elongated length and expanded width.

Please refer to FIGS. 1 to 7. The LED module 4 is located in the extruded frame 2. The LED module 4 has a circuit board and a plurality of light emitting diodes (LEDs) assembled on the circuit board. The luminous power of the LED module 4 is less than 70 W. The luminous power of the LED module 4 may be 70 W for high power use, or may be less than 30 W for low power use.

Please refer to FIGS. 1 to 7. The power device 5 is fixed on one end of the space in the extruded frame 2. The power device 5 is electrically connected to the LED module 4 to supply electricity for the LED module 4. The power device 5 is also connected to the connectors 9 on the side covers 8 to receive mains electricity.

Please refer to FIGS. 1 to 7. The manual switch 6 is electrically connected to the LED module 4, so that the manual switch 6 can be used for controlling the LED module 4 to be turned on or turned off. The manual switch 6 comprises a pulling line 7 extending out of the extruded frame 2. Therefore, a user can pull the pulling line 7 to control an elastic terminal sheet to contact or not to contact the LED module 4 so as to allow the conduction between the electricity and the LED module 4. Moreover, the manual switch 6 comprises a connection member 17, and the extruded frame 2 comprises a positioning groove 18 for positioning with the connection member 17.

Please refer to FIGS. 1 to 7. The housing 3 is assembled to one of two opposite sides of the extruded frame 2, and a plurality of hooks 16 is assembled on the other side of the extruded frame 2. The hooks 16 can be buckled with the buckling rings assembled on the wall of a store. Therefore, the portable light 100 can be fixed on the wall to illuminate the merchandises of the store.

In this embodiment, the portable light is used for shop illuminations, and the portable light is also called shop light. The structure of the extruded frame and the notches on the surface of the extruded frame allow the portable light to have great heat dissipation. When the LED module emits lights, though the heat generated by the LED module is gathered on the circuit board, such heat can be dissipated through the extruded frame. Therefore, the LED module does not have luminous attenuation due to being overheating.

In this embodiment, the pulling line is extending from the portable light, so that a user can pull the pulling line to turn on or turn off the portable light in a convenient manner. Conversely, it is understood that the conventional light can be turned on or turned off by the switch assembled on the wall, resulting in inconvenience for the user.

The LED module may be a high luminous-power LED module or a low luminous-power LED module, and the luminous power of the LED module may be up to 70 W. Furthermore, because the heat dissipation problem of the LED module is solved, the LED module may comprise LEDs with less number but higher luminous power to improve the illumination efficiency.

Moreover, the protruded arced surface of the housing increases an illumination area of the portable light. Accordingly, when the light emitted by the LED module is passing through the protruded arced surface, a uniform and larger illumination area can be provided. Additionally, the connectors of several portable lights can be connected with each other through wires, so that several portable lights can be connected with each other in series connection for further use.

Moreover, it is understood that the surface of the frame of a conventional light has extrusion marks, and the extrusion marks maybe damaged or deformed easily when being forced. In one embodiment, the extruded frame of the portable light has a proper design in which the surface of the extruded frame provided with the notches. The notches form a decoration structure for the extruded frame without extrusion marks. Moreover, the notches allow the extruded frame to have improved structural strength and not to deform easily.

Although particular embodiments of the invention have been described in detail for purposes of illustration, various modifications and enhancements may be made without departing from the spirit and scope of the invention. Accordingly, the invention is not to be limited except as by the appended claims. For example, the housing may further have pulling line, rounded angle, or the illumination angle of the LED module may be expanded.

As above, the prevent invention is innovative and has the improved performance. The present invention is non-obvious in view of the relevant arts and has inventive steps and utility.

Those skilled in the art will readily observe that numerous modifications and alterations of the device and method may be made while retaining the teachings of the invention. Accordingly, the above disclosure should be construed as limited only by the metes and bounds of the appended claims.

1. A portable light, comprising:
an extruded frame, comprising two side plates, a top plate connected to top portions of the two side plates, and a bottom plate connected to bottom portions of the two side plates, wherein a width between the top portions of the two side plates is less than a width between the bottom portions of the two side plates in a cross-sectional view of the extruded frame along a width direction of the portable light, so that in the cross-sectional view the extruded frame has a trapezoidal structure, the extruded frame comprises a receiving space defined by the two side plates, the top plate, and the bottom plate;
a housing fixed on the bottom plate, wherein a light illumination space is formed between the bottom plate and the housing;
a LED module located on the bottom plate and facing the light illumination space and the housing;
a power device located in the extruded frame and electrically connected to the LED module; and
a manual switch electrically connected to the LED module to control the LED module to be turned on or off, wherein the manual switch comprises a pulling line extending out of the extruded frame.

2. The portable light according to claim 1, wherein the bottom plate is recessed inwardly toward the receiving space, so that an area of the light illumination space increases.

3. The portable light according to claim 1, wherein two ends of the extruded frame are combined with side covers, and a surface of each of the side covers forms a connector.

4. The portable light according to claim 1, wherein a surface of the extruded frame forms a plurality of notches.

5. The portable light according to claim 1, wherein a protruding arced surface is formed on the housing to increase an illumination area of the portable light.

6. The portable light according to claim 5, wherein two ends of the housing are provided with engaging grooves, and two ends of a side portion of the extruded frame are provided with engaging blocks for being engaged with the engaging grooves.

7. (canceled)

8. The portable light according to claim 1, wherein a plurality of hooks is assembled on the top plate of the extruded frame.

9. The portable light according to claim 1, wherein the manual switch comprises a connection member, and the extruded frame comprises a positioning groove for positioning with the connection member.

10. The portable light according to claim 1, wherein a luminous power of the LED module is 70 W.
